(19) United States
(12) Patent Application Publication
(10) Pub. No.: US 2013/0180355 A1
(43) Pub. Date: Jul. 18, 2013

(54) MODULARIZED BICYCLE PEDAL

(71) Applicant: Wen-Hwa LIN, Taichung City (TW)

(72) Inventor: Wen-Hwa LIN, Taichung City (TW)

(73) Assignee: VP COMPONENTS CO., LTD., Taichung City (TW)

(21) Appl. No.: 13/352,077

(22) Filed: Jan. 17, 2012

(51) Int. Cl. B62M 3/08; G05G 1/445

(52) U.S. Cl. 74/560

(57) ABSTRACT

A modularized bicycle pedal includes a pedal body and a shaft module. The pedal body has a connecting side provided with a socket portion. The shaft module includes a circular enclosure, a shaft core and plural rolling units. The enclosure has a circular inner surface that defines a through hole. The enclosure is received in the socket portion and coupled to the pedal body. The shaft core partially protrudes into the through hole. The shaft core has a connecting segment and a first sustaining segment. The connecting segment is configured to connect the crank. The rolling units are rotatably sandwiched by the circular inner surface and the first sustaining segment, so that the shaft core is allowed to rotate with respect to the enclosure against an axis.

### BACKGROUND OF THE INVENTION

1. Technical Field

The present invention relates to bicycle pedals, and more particularly, to a modularized bicycle pedal featuring an integrated shaft module.

2. Description of Related Art

In a bicycle, pedals are provided for a cyclist to pedal and thereby drive the bicycle cranks to in turn drive the chain system and wheels and finally make the bicycle go forward.

One of the conventional pedals is shown in Taiwan Patent No. TW M405404. The prior-art device has a pedal body formed therein with a whole-width shaft hole for rotatably receiving a shaft that has one end coupled to a crank. In such a structure, the shaft extending throughout the width of the pedal body necessarily makes the pedal body thick and heavy and, therefore, tends to hinder the cyclist when he/she is making turns on the bicycle.

For avoiding this inconvenience, Taiwan Patent No. TW M405404 has disclosed a thin pedal by attaching a shaft to merely one side of a pedal body. In particular, the pedal body has an axle and the shaft includes a connector, a first bearing and a second bearing. The first bearing, the connector and the second bearing are mounted around the axle in order, and the assembly is then coupled to a crank. Finally, fixing units are used to secure combination of the pedal body and the shaft. However, one problem with the thin pedal of TW M405404 is that the combination of the components can fall apart anytime before the fixing units are screwed into the axle. Particularly, the connector and bearings of the shaft are not integrated as a module so the in-situ assembling work is troublesome.

Taiwan Patent No. TW M297904 has provided a pedal similar to the one described in the preceding paragraph. In this prior-art pedal, a pedal body has its one side formed with a shaft seat, and a shaft is composed of a core, a sleeve and a plurality of bearings. The core is stepped and the sleeve has its inner periphery provided with a stepped surface. Thereby, after the core and bearings are put into the sleeve in order, a nut screwed with one end of the core serves to hold the bearings and sleeve in position. Although the pedal of TW M297904 is advantageous because the shaft can be preassembled for easy storage and transportation, the core has to be long for accommodating a threaded segment that engages the nut. In addition to the lengthened core, the nut also adds weight to the overall pedal, and this is not conformable to the consumers' pursuit of light and compact bicycle parts.

While Taiwan Patent No. TW M405404 and Taiwan Patent No. TW M297904 have tried to reduce the volume and weight of a pedal by attaching the shaft to merely one side of the pedal body, the bearings are fixed to the shaft core by additional screw means, so there is still a room for further simplifying and lightening bicycle pedals.

### SUMMARY OF THE INVENTION

A primary objective of the present invention is to provide a bicycle pedal featuring a shaft module that can be preassembled and is compact and light.

To this end, the modularized bicycle pedal is adaptive to be rotatably coupled to a bicycle crank and includes a pedal body and a shaft module. The pedal body has a connecting side provided with a socket portion. The shaft module includes a circular enclosure, a shaft core and plural rolling units. The enclosure has a circular inner surface that defines a through hole. The enclosure is received in the socket portion and coupled to the pedal body. The shaft core partially protrudes into the through hole. The shaft core has a connecting segment and a first sustaining segment. The connecting segment is configured to connect the crank. The rolling units are rotatably sandwiched by the circular inner surface and the first sustaining segment, so that the shaft core is allowed to rotate with respect to the enclosure against an axis.

With the foregoing configuration, the disclosed modularized bicycle pedal can have the shaft module preassembled for easy storage and use. Also, in the present invention, the rolling units located immediately between the enclosure and the shaft core preferably serve to prevent the enclosure from axially moving with respect to the shaft core, so the need of using plural bearings and fasteners as existing in the prior art can be eliminated, thereby reducing the overall weight of the pedal.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a modularized bicycle pedal according to one embodiment of the present invention;

FIG. 2 is an exploded view of the modularized bicycle pedal of FIG. 1;

FIG. 3 is a perspective view of the modularized bicycle pedal of FIG. 1, wherein the preassembled shaft module is to be assembled to the pedal body;

FIG. 4 is a lateral view of the modularized bicycle pedal of FIG. 1 assembled with a bicycle crank;

FIG. 5 is a partial, cross-sectional view of the modularized bicycle pedal of FIG. 1;

FIG. 5A is an enlarged view of the circled part in FIG. 5;

FIG. 6 is a partial, cross-sectional view of the shaft module as shown in FIG. 3; and

FIG. 6A is an enlarged view of the circled part in FIG. 6.

### DETAILED DESCRIPTION OF THE INVENTION

The following preferred embodiments when read with the accompanying drawings are made to clearly exhibit the above-mentioned and other technical contents, features and effects of the present invention. However, the accompanying drawings are intended for reference and illustration, but not to limit the present invention and are not made to scale. Unless otherwise noted, like elements will be identified by identical numbers throughout all figures.

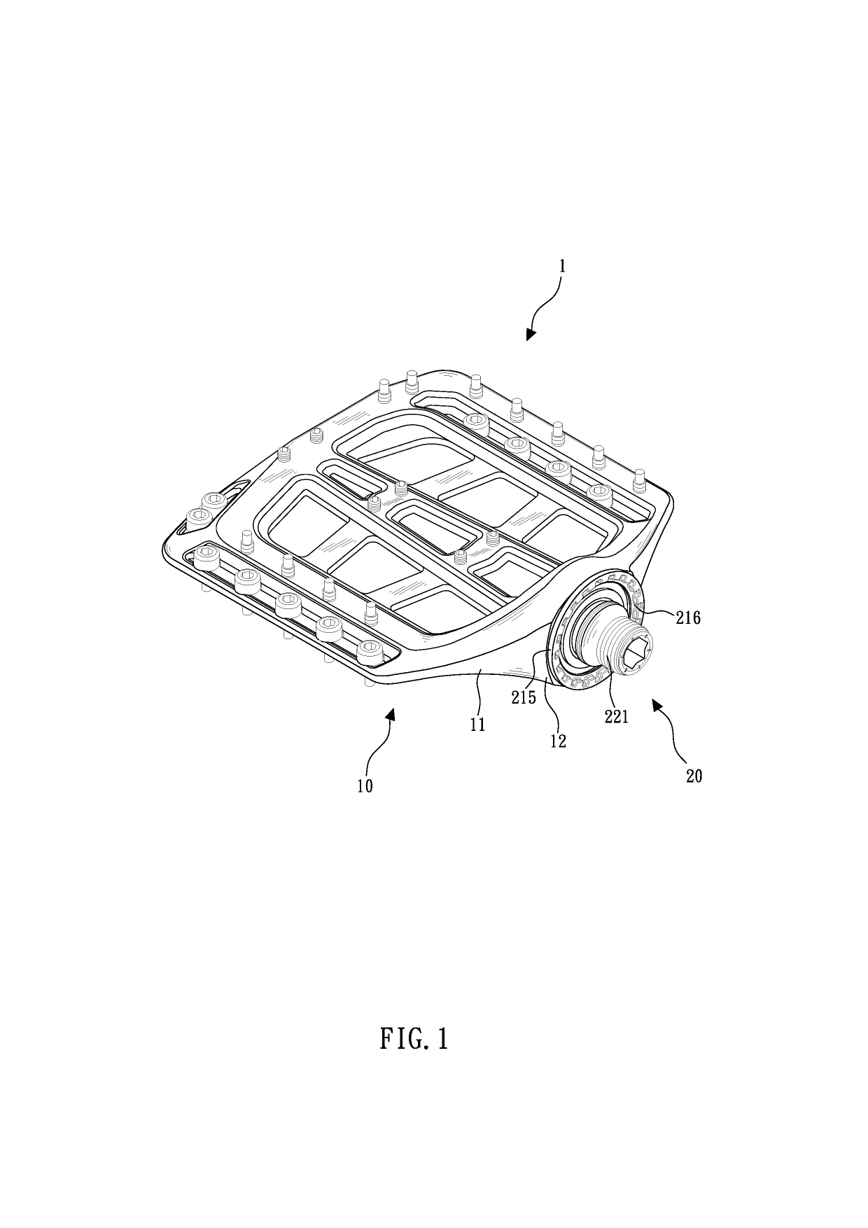

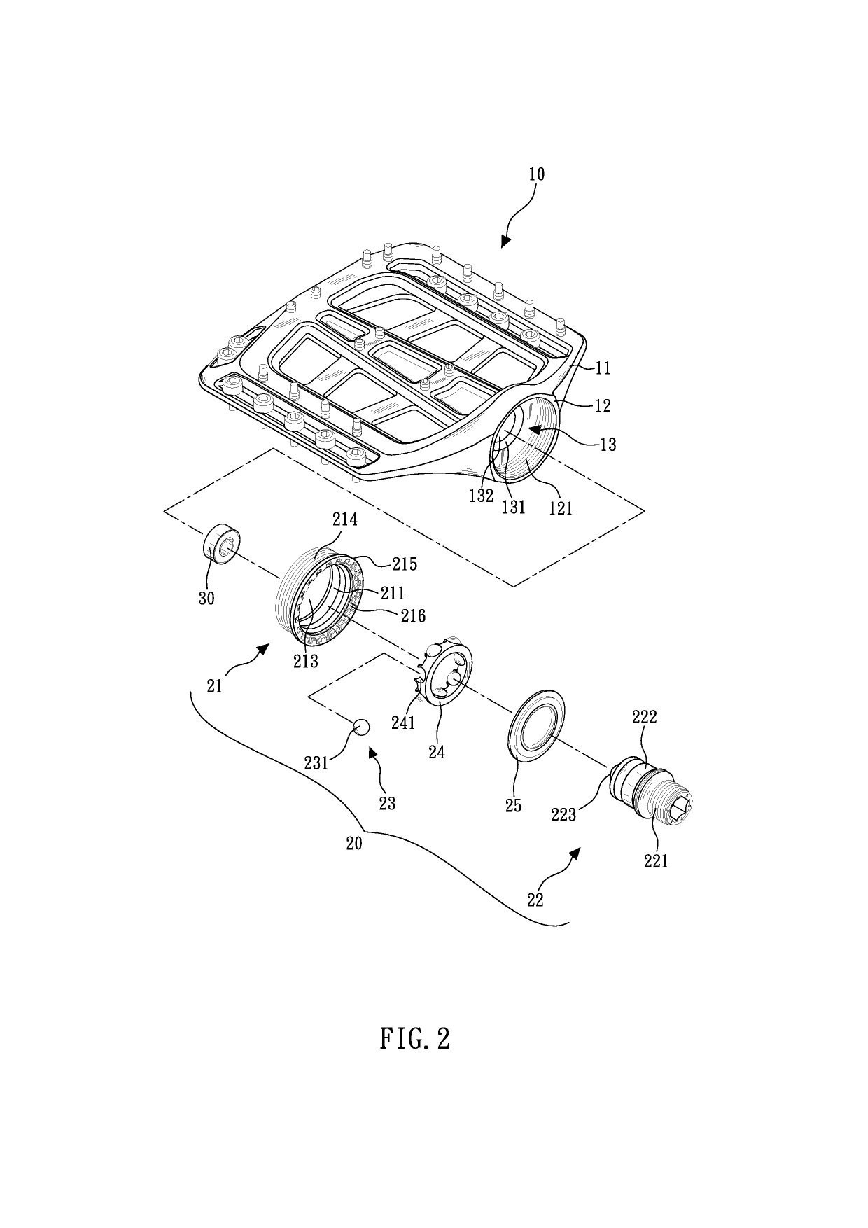

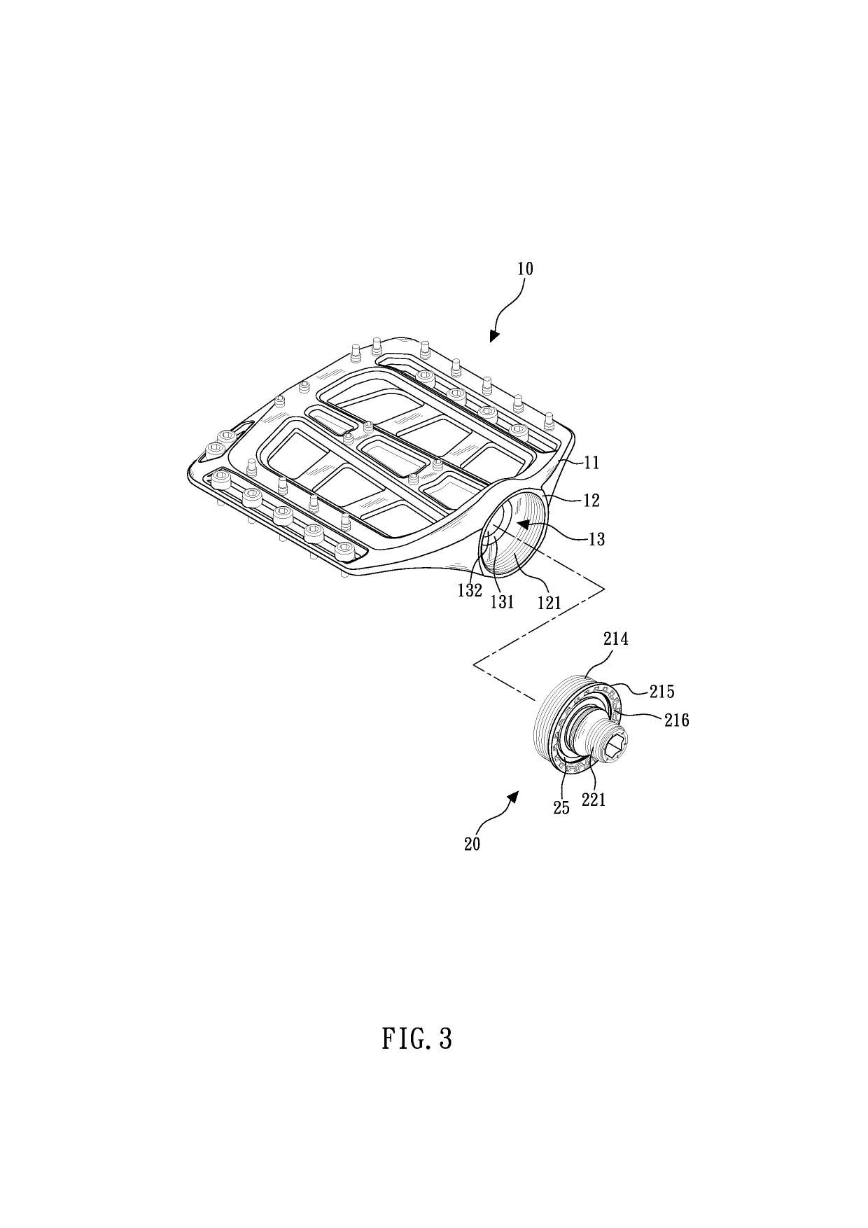

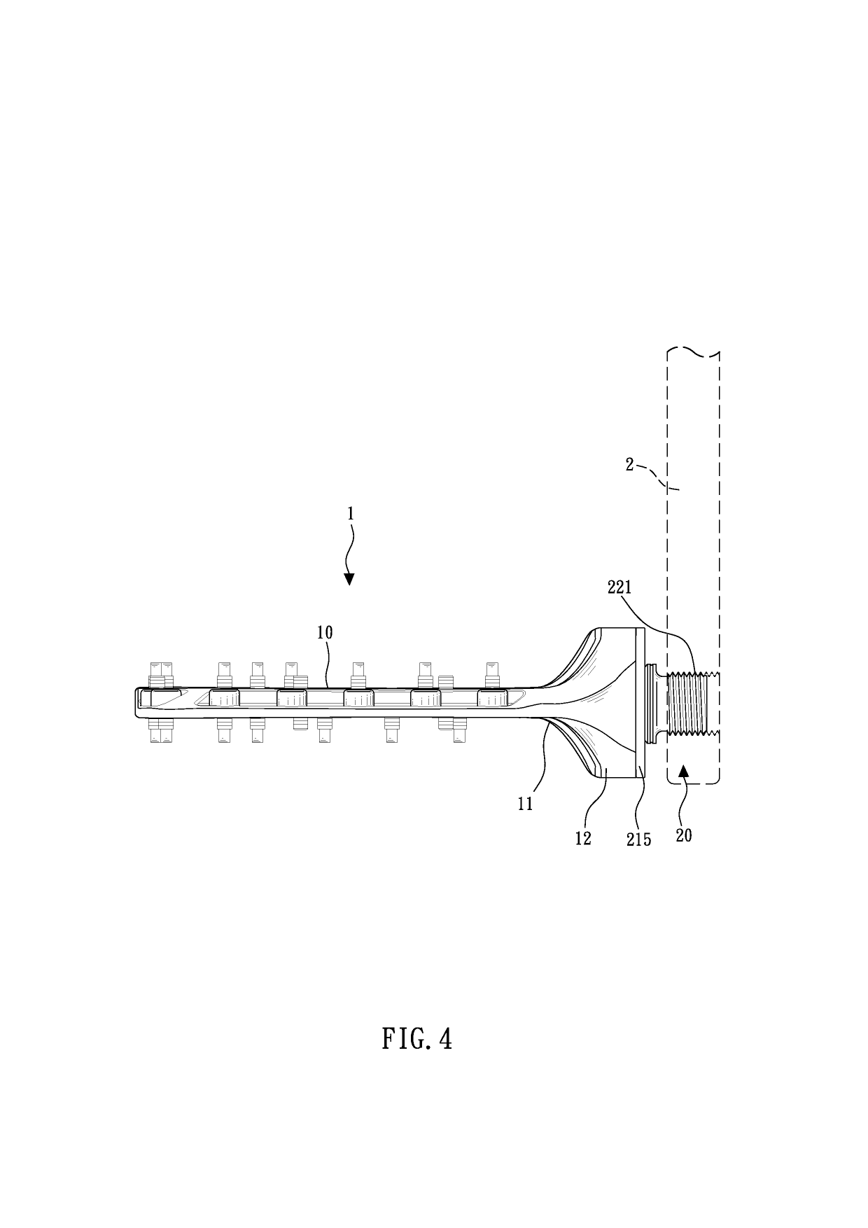

Referring to FIG. 1 through FIG. 5, according to one embodiment of the present invention, a modularized bicycle pedal 1 is adaptive to be rotatably coupled to a bicycle crank 2. The modularized bicycle pedal 1 comprises a pedal body 10, a shaft module 20 and a bearing 30.

The pedal body 10 has one connecting side 11 for connecting the crank 2 on which a socket portion 12 is provided. Preferably, the socket portion 12 is formed with an internal threaded segment 121 and the socket portion 12 has centrally a socket 13 defined by a circular wall 131 and an end wall 132.

The shaft module 20 includes a circular enclosure 21, a shaft core 22, a plurality of rolling units 23, a circular ball retainer 24 and an oil seal 25.

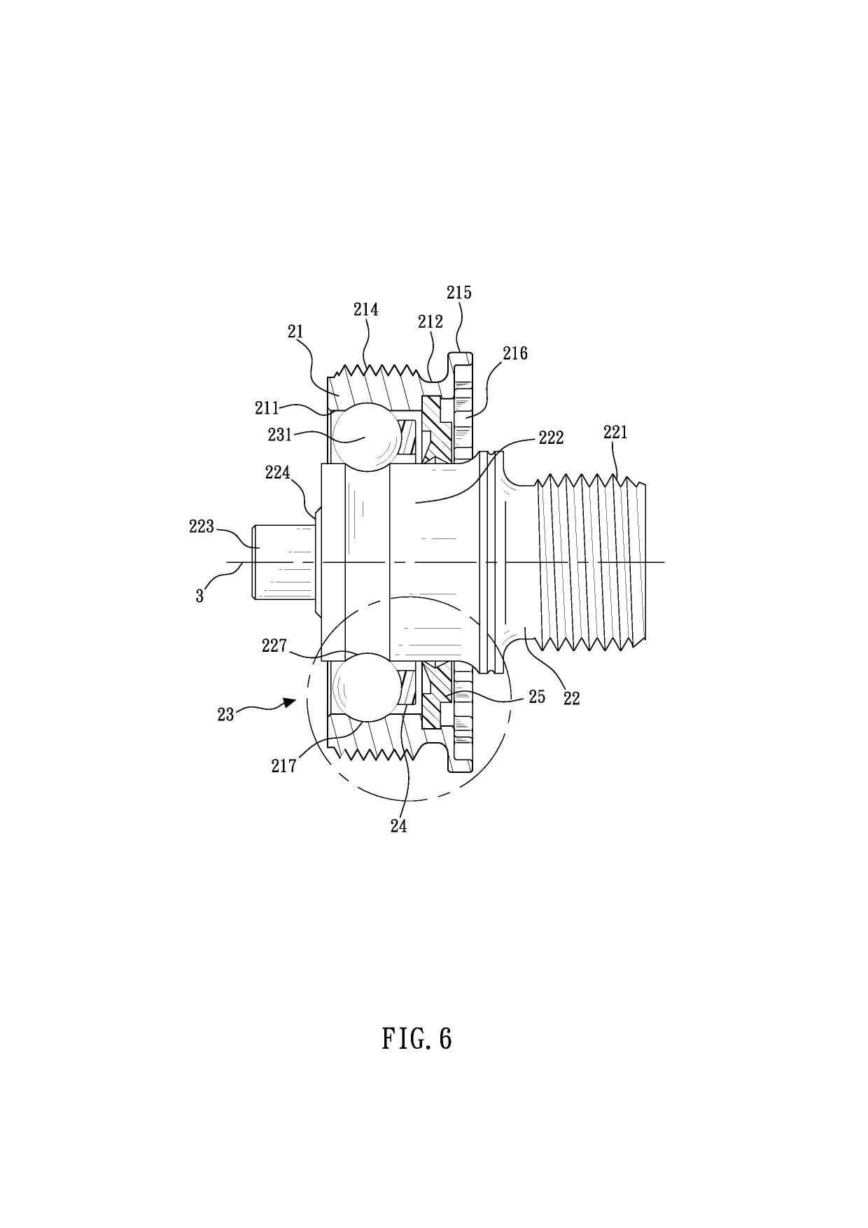

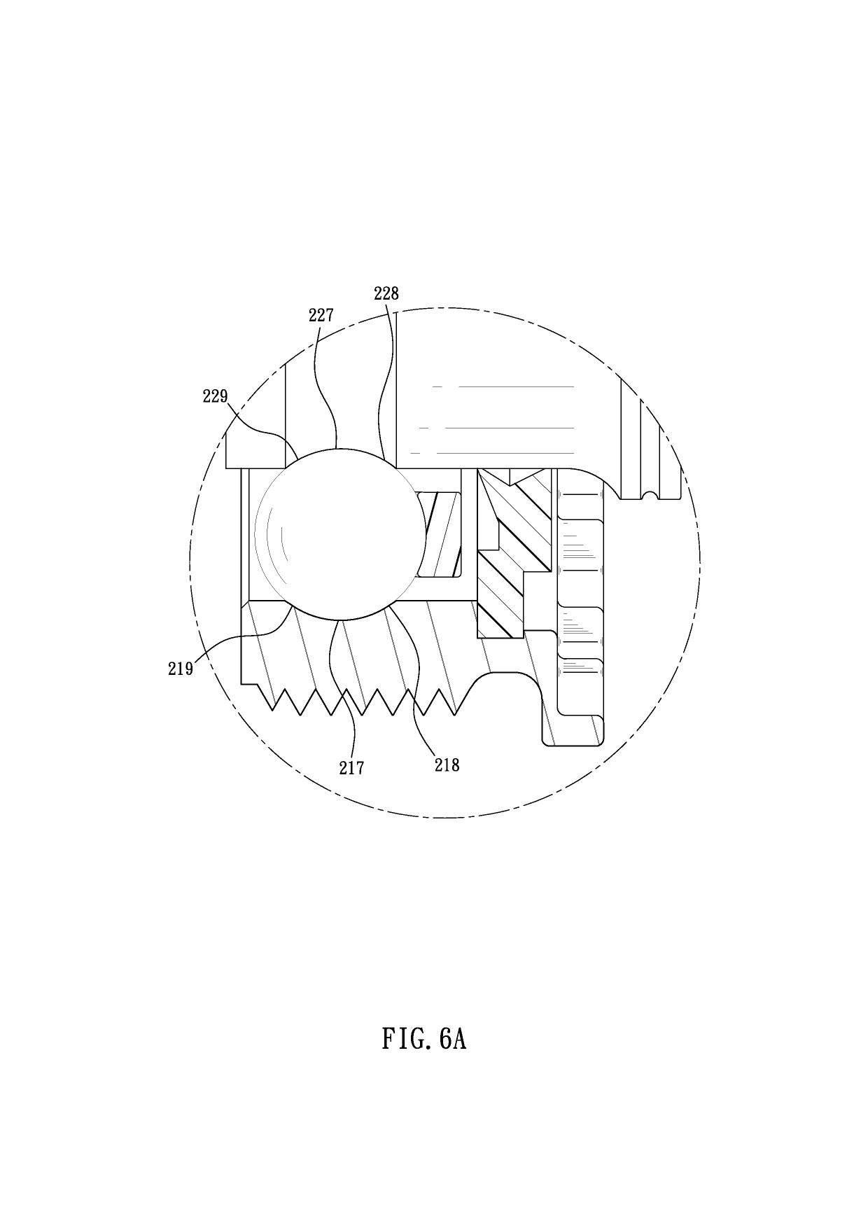

Now referring to FIG. 6, the enclosure 21 has a circular inner surface 211 and a circular outer surface 212. The circular inner surface 211 defines a through hole 213, while the circular outer surface 212 is formed with an external threaded segment 214. Thereby, when the enclosure 21 is assembled to the socket portion 12, the enclosure 21 and the socket portion 12 are screwedly engaged with each other, so the shaft module 20 is connected to the pedal body 10. Preferably, the enclosure 21 further has a radially extended lip portion 215. The lip portion 215 has a non-circular profile 216, such as a saw-toothed profile, as shown, or a polyhedral or wavy profile, so that a specific driver (not shown) matches the non-circular profile 216 can be used to rotate and engage the enclosure 21 against and with the socket portion 12.

The shaft core 22, after the foregoing assembling operation, protrudes into the through hole 213. The shaft core 22 has a connecting segment 221 for connecting the crank 2, a first sustaining segment 222 facing the circular inner surface 211 and a second sustaining segment 223. The connecting segment 221 may be connected to the crank 2 by means of, for example, threads. The first sustaining segment 222 is located between the connecting segment 221 and the second sustaining segment 223, while the second sustaining segment 223 is located within the socket 13. Preferably, the first sustaining segment 222 is larger than the second sustaining segment 223 in diameter. Additionally, the shaft core 22 has a retaining surface 224 located between the first and second sustaining segments 222, 223. The retaining surface 224 is perpendicular to an axis 3.

The rolling units 23 are rotatably sandwiched by the circular inner surface 211 and the first sustaining segment 222, so that the shaft core 22 is allowed to rotate against the axis 3 with respect to the enclosure 21. Further referring to FIG. 6A, the rolling units 23 preferably include plural spherical balls 231, and the circular inner surface 211 has a circular first ball groove 217, while the first sustaining segment 222 has a circular second ball groove 227. Each of the balls 231 is configured to abut against the first, second ball grooves 217, 227. The first ball groove 217 has a first outer sidewall 218 near the crank 2 and a first inner sidewall 219 near the pedal body 10, while the second ball groove 227 has a second outer sidewall 228 near the crank 2 and a second inner sidewall 229 near the pedal body 10. The first and second outer sidewalls 218, 228 and the first and second inner sidewalls 219, 229 jointly press on the balls 231 so as to prohibit the enclosure 21 from moving axially with respect to the shaft core 22.

The ball retainer 24 has a plurality of separated ball seats 241, each for receiving one said ball 231, thereby positioning the balls 231 with respect to their adjacent balls 231 and in turn making the balls 231 bearing force uniformly.

The oil seal 25 arranged between the rolling units 23 and the connecting segment 221 may be circular to seal a gap between the enclosure 21 and the shaft core 22 that otherwise is open to the crank 2, thereby preventing lubricant inside the shaft module 20 from leaking out and preventing foreign articles from intruding into the space between the enclosure 21 and the shaft core 22.

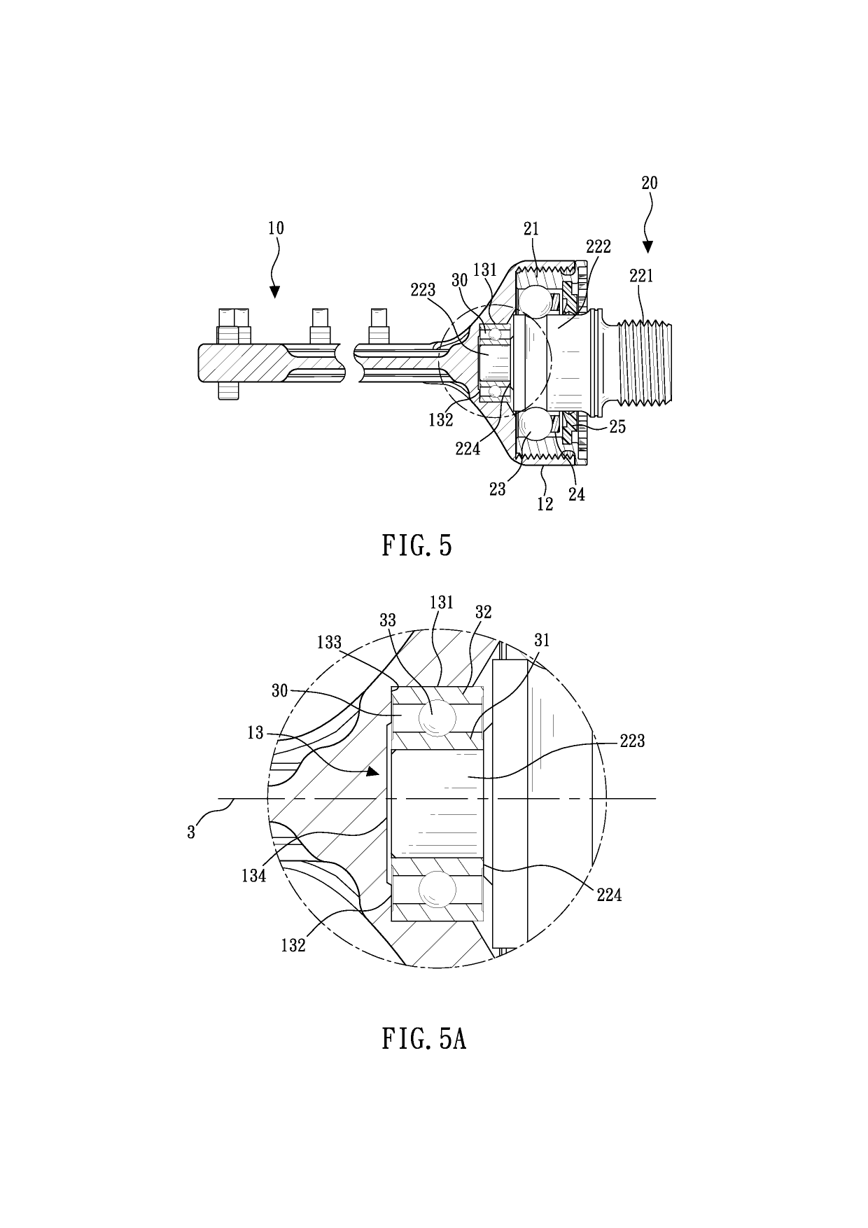

The bearing 30 is rotatably sandwiched by the circular wall 131 and the second sustaining segment 223. Preferably, the bearing 30 is fittingly received between the retaining surface 224 and the end wall 132 of the socket 13. For example, as the enclosure 21 and the socket portion 12 are screwed together, the bearing 30 is increasingly pushed toward and finally abut against the end wall 132, so the bearing 30 is retained from moving axially with respect to the shaft core 22. Further referring to FIG. 5A, the bearing 30 preferably includes an inner ring 31, an outer ring 32 and plural rolling units 33 between the inner and outer rings 31, 32. The inner and outer rings 31, 32 are configured to rotate with respect to each other against the axis 3. The inner ring 31 is mounted around the second sustaining segment 223, and the outer ring 32 is inlaid in the circular wall 131 of the socket 13. The end wall 132 of the socket 13 has a pressing segment 133 and a non-pressing segment 134. The pressing segment 133 immediately abuts against the outer ring 32 in the axial direction, and the non-pressing segment 134 does not contact the bearing 30, while the retaining surface 224 immediately abuts against the inner ring 31 in the axial direction, thereby further reduce resistance to the rotation of the shaft core 22 with respect to the pedal body 10.

With the foregoing features, the present invention provides following improvements.

First, the shaft module can be preassembled and this modularized assembly can be easily transported and stored. In the event that the shaft module is consumed, it can be easily disassembled and get replaced by a new shaft module.

Second, in the present invention, the rolling units serve to not only allow axial displacement between the shaft core and the enclosure, but also prohibit the enclosure and the shaft core from moving axially with respect to each other. In other words, the rolling units as disclosed works conventionally to allow rotation, and works uniquely to position two adjacent components. On the other hand, in a traditional shaft module, the bearing only serves to allow rotation, and is not designed to provide any additional function such as prohibiting the enclosure and the shaft core from axial movement, so at least one additional screw has to be used to fix the enclosure with the shaft core. Since the present invention eliminates the use of such one or more screws, the disclosed shaft module is structurally simpler as compared with the prior-art device.

Third, the present invention integrates the bearing otherwise provided separately into the shaft module. In other words, the present invention makes the rolling units immediately located between the enclosure and the shaft core, so the resultant shaft module can have significantly reduced length, volume and weight, thereby catering to the consumers' needs better.

Forth, since the present invention implements the rolling units instead of the traditional bearing, pedal manufactures can save some costs for sourcing bearings, and thereby have a higher profit margin.

Fifth, because the disclosed shaft module is merely provided at one side of the pedal body, the rest part of the pedal body can have reduced thickness. This allows the pedal to be light. Also, the thin pedal is less likely to hinder the cyclist when he/she is making turns on the bicycle.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A modularized bicycle pedal being adaptive to be rotatably coupled to a bicycle crank, and comprising:
a pedal body having a connecting side for connecting the crank and a socket portion provided at the connecting side; and
a shaft module including a circular enclosure, a shaft core and a plurality of rolling units, the enclosure having a circular inner surface that defines a through hole, the enclosure being received in the socket portion and coupled to the pedal body, the shaft core protruding into the through hole, the shaft core having a connecting segment near the crank and a first sustaining segment facing the circular inner surface, the connecting segment being connected to the crank, and the rolling units being rotatably sandwiched by the circular inner surface and the first sustaining segment, so that the shaft core is allowed to rotate with respect to the enclosure against an axis;
wherein the rolling units comprise a plurality of spherical balls, the circular inner surface having a circular first ball groove, the first sustaining segment having a circular second ball groove, each said ball abutting against the first and second ball grooves, the first ball groove having a first outer sidewall near the crank and a first inner sidewall near the pedal body, the second ball groove having a second outer sidewall near the crank and a second inner sidewall near the pedal body, and the first and second outer sidewalls and the first and second inner sidewalls abutting against the balls, thereby preventing the enclosure and the shaft core from axially moving with respect to each other.

2. (canceled)

3. The modularized bicycle pedal of claim 1, wherein the shaft module further comprises a circular ball retainer that has a plurality of separate ball seats for each receiving one said ball therein.

4. The modularized bicycle pedal of claim 1, further comprising a bearing, the socket portion being centrally formed with a socket that is defined by a circular wall and an end wall facing the crank, the shaft core further having a second sustaining segment that is near the pedal body, the second sustaining segment being located within the socket, and the bearing being rotatably sandwiched by the circular wall and the second sustaining segment.

5. The modularized bicycle pedal of claim 4, wherein the shaft core has a retaining surface that is perpendicular to the axis and located between the first and second sustaining segments, such that the bearing is fittingly held between the retaining surface and the end wall of the socket, whereby the bearing is retained from axially moving with respect to the shaft core.

6. The modularized bicycle pedal of claim 5, wherein the bearing comprises an inner ring, an outer ring and a plurality of rolling units located between the inner and outer ring, the inner and outer rings being configured to rotate with respect to each other against the axis, the inner ring being mounted around the second sustaining segment, the outer ring being inlaid in the circular wall of the socket, the end wall of the socket having a pressing segment and a non-pressing segment, the pressing segment axially abutting against the outer ring immediately, the non-pressing segment not contacting the bearing, and the retaining surface axially abutting against the inner ring immediately.

7. The modularized bicycle pedal of claim 1, wherein the socket portion is further formed with an internal threaded segment, and the enclosure further has a circular outer surface that is formed with an external threaded segment, so that the enclosure and the socket portion are screwedly coupled through the internal and external threaded segments.

8. The modularized bicycle pedal of claim 7, wherein the enclosure includes a radially extended lip portion that has a non-circular profile for a matching driver to rotate the enclosure with respect to the socket portion.

9. The modularized bicycle pedal of claim 1, wherein the shaft module further comprises an oil seal located between the rolling units and the connecting segment.
